(19) United States
(12) Patent Application Publication
(10) Pub. No.: US 2023/0200581 A1
(43) Pub. Date: Jun. 29, 2023

(54) Appliance for Dissolving Components of a Solid Material in Water to Make a Beverage

(71) Applicant: Hang Shun Hing Company Limited, Kwun Tong, Kowloon (HK)

(72) Inventor: Man Fai Cheung, Kwun Tong (HK)

(21) Appl. No.: 17/923,376

(22) PCT Filed: Jun. 25, 2021
(86) PCT No.: PCT/CN2021/102257

§ 371 Date: Nov. 4, 2022

(30) Foreign Application Priority Data
Jul. 30, 2020 (HK) 32020012982.5

(51) Int. Cl. A47J 31/32; A47J 31/06; A47J 31/52; A47J 31/46

(52) U.S. Cl. CPC A47J 31/32; A47J 31/0636; A47J 31/5251; A47J 31/461

(57) ABSTRACT

To enhance extraction and dissolution of soluble components of a solid material in water to make a beverage, an appliance comprises a serving chamber, a pressure regulating system, a filter assembly, a brewing chamber, a liquid passageway and a controller that controls the pressure regulating system to alternately de-pressurize and pressurize the brewing chamber is provided. The appliance further comprises a foam filter to reduce the amount of foam in the beverage.

### TECHNICAL FIELD

The present invention relates to a beverage-making appliance that performs an extraction process in which components of a solid material are dissolved in water.

### BACKGROUND OF THE INVENTION

Preparing infusions by soaking tea leaves, herbs, or the like, in cold water, is an ancient technique still popular today, as evidenced by the current interest in cold brewed coffee. Using water at room temperature produces beverages with a different flavour profile, considered superior compared to high energy methods such as using steam or hot water, that extract components having a lower solubility. However, the 8 to 12 hours that the process typically requires is too much time for the ordinary consumer. It is an object of the present invention to address this disadvantage or, more particularly, to provide an improved beverage-making appliance.

### DISCLOSURE OF THE INVENTION

According to the present invention there is provided an appliance for dissolving components of a solid material in water to make a beverage, comprising:

a serving chamber adapted to hold a beverage serving, the serving chamber having a base;

a brewing chamber adapted to hold the beverage serving;

a pressure regulating system for depressurizing and pressurizing the brewing chamber with air;

a channel providing fluid communication between the brewing chamber and the base of the brewing chamber;

a filter assembly for removing the solid material from the water, the filter assembly disposed in the channel, and

a controller that controls the pressure regulating system to alternately (i) depressurize the brewing chamber to draw water out of the serving chamber and through the channel and the filter assembly into the brewing chamber and (ii) pressurize the brewing chamber to push the beverage serving from the brewing chamber through the filter assembly and the channel to the serving chamber.

A particular advantage of the invention may be the manner in which air, which inevitably mixes with the last part of the water drawn through the channel into the filter assembly causes short-lived agitation to the solid material in the filter assembly.

Preferably the depressurizing and pressurizing of the brewing chamber are repeated for a plurality of cycles. Advantageously, this provides multiple extractions and enhances the rate of dissolution of soluble components into the water.

Preferably the brewing chamber, filter assembly and serving chamber are detachably connected together, with the brewing chamber disposed uppermost and the filter assembly disposed between the brewing chamber and the serving chamber, and further comprising a tube releasably connectable at its upper end to the filter assembly, and wherein its lower end is spaced from the base, the tube defining a lower section of the channel. Alternatively, the brewing chamber may be fixed to the serving chamber side by side.

Preferably the tube is straight and extends substantially centrally through the serving chamber.

Preferably, the appliance further comprises a foam filter adapted to remove foam formed in the beverage. Excessive foam in the beverage may be undesirable as it tends to adversely affect the mouthfeel and flavour of the beverage, so it is advantageous to have a foam filter able to filter out foam.

Preferably the foam filter comprises a wall extending around and spaced apart from the tube and substantially longitudinally coextensive therewith. Preferably the wall is substantially imperforate. Preferably the wall includes castellations at an upper end thereof. Preferably, the foam filter further comprises castellations at an opposing lower end thereof.

Preferably the wall of the foam filter tapers to narrow toward its lower end. Preferably the continuous wall is in form of a conical frustum.

Preferably the foam filter and the tube are integrally formed. Beneficially, this reduces manufacturing cost and simplifies the assembling process by the user.

Preferably the serving chamber comprises transparent walls, or a transparent window, and the wall of the foam filter is opaque.

Preferably a removable closure closes an open mouth of the brewing chamber, and the removable closure encloses the pressure regulating system and the controller. Alternatively, the pressure regulating system, the controller and/or other components can be provided in a handle assembly connected to the appliance. The removable closure can be removed to facilitate cleaning of the brewing chamber after use to avoid damage of the electrical components enclosed by the closure by water and cleaning agents.

Preferably a venting device provides a small metered air flow between the brewing chamber and the surrounding atmosphere during both depressurizing and pressurizing the brewing chamber. Preferably the venting device comprises a capillary tube. Alternatively, the flow regulating device may be a venturi.

Preferably the pressure regulating system comprises a circuit having a first leg connected between the brewing chamber and an inlet side of the pneumatic pump and a second leg connected between the brewing chamber and an outlet side of the pneumatic pump, and a first 3-way solenoid valve in the first leg and a second 3-way solenoid valve in the second leg.

The controller controls the pneumatic pump and the two solenoid valves to selectively draw air out of the brewing chamber or force air into the brewing chamber.

Preferably, the appliance further comprises a pressure sensor and a pressure signal from the pressure sensor triggers a changeover between pressurizing and depressurizing the brewing chamber.

Optionally, the controller further comprises a timer, and the controller triggers the changeover between each mode of pressurizing and depressurizing according an elapsed operating time of the preceding mode.

Preferably, only one of the pressure sensor and the timer is activated at a time.

Preferably, the lower part of the filter assembly is received in an upper part of the serving chamber, and the brewing chamber and the serving chamber are coaxially disposed.

Preferably the filter assembly comprises a filter cup with a filter element at its base and a filter cup holder for receiving the filter cup, with the solid material being held between the filter element and the lower part of the brewing chamber. Advantageously, the filter cup and the filter cup holder can be detached from each other for easy cleaning before and after use.

Preferably the filter element comprises a mesh. Alternatively, other filtration means such as a paper filter may be used.

Preferably the filter assembly and the brewing chamber are screw threaded to each other.

Preferably the appliance is a cold brewing appliance without any heating element for heating the water.

The present invention is suitable for making a beverage from a large variety of solid materials, including ground coffee, tea leaves, herbs, fruits, and Chinese medicine.

In another aspect, the invention provides a method for making a beverage comprising alternately the steps of:

(i) depressurizing a brewing chamber to draw water out of a serving chamber and through a channel in which is a filter assembly holding solid material and into a brewing chamber to thereby dissolve components of the solid material in the water, and

(ii) pressurizing the brewing chamber to push the beverage from the brewing chamber through the filter assembly and the channel into the serving chamber.

Preferably, the channel is formed in a tube and, after passing through the tube, at least a portion of the beverage passes through a foam filter surrounding a length of the tube. Advantageously, foam in the beverage serving is either broken down in the foam filter or trapped in a space between an outer surface of the tube and an inner surface of the foam filter.

Preferably, the air pressure in the serving chamber is maintained substantially at ambient pressure.

Preferably, the steps (i) and (ii) of alternately depressurizing and pressurizing the brewing chamber are repeated for multiple cycles for multiple extractions of soluble components into water to make a richer beverage.

Preferably the method for making a beverage further comprises:

placing a filter cup into a filter cup holder to form a filter assembly;

placing an amount of a solid material into the filter assembly;

connecting the filter assembly to a brewing chamber;

connecting the brewing chamber to a removable closure;

connecting the filter assembly to a liquid passageway;

placing an amount of water into a serving chamber; and

connecting the brewing chamber to the serving chamber.

### BRIEF DESCRIPTION OF THE DRAWINGS

Preferred forms of the present invention will now be described by way of example with reference to the accompanying drawings, wherein:

FIG. 1 is an exploded view of a beverage-making appliance according to an embodiment of the invention;

FIG. 2 is a section in an upright plane of the assembled appliance of FIG. 1;

FIG. 3 is a schematic of a pneumatic circuit of the appliance of FIG. 1, and

FIG. 4 is a schematic circuit diagram of the controller of the appliance of FIG. 1.

### DESCRIPTION OF THE PREFERRED EMBODIMENTS

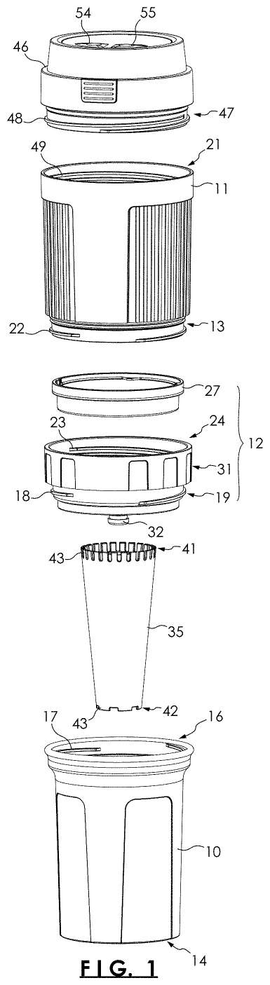

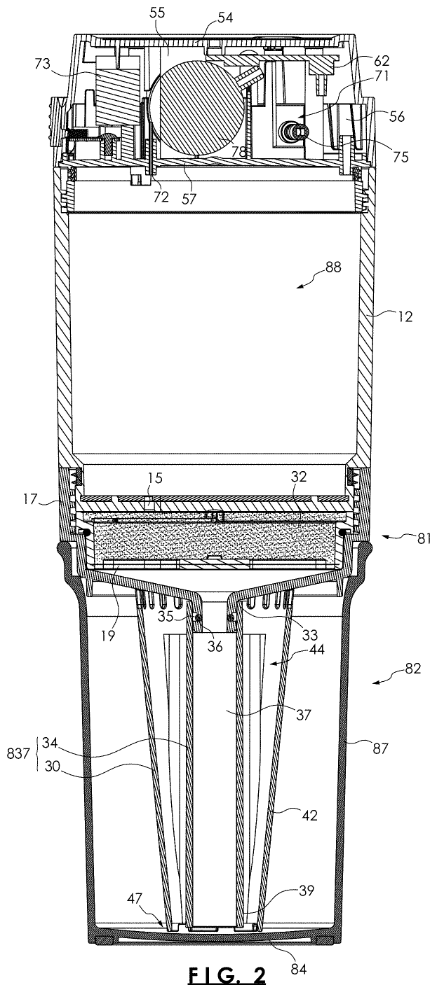

Referring to FIGS. 1 and 2, an appliance for dissolving components of a solid material in water to make a beverage according to an embodiment of the present invention generally comprises a serving chamber 10 adapted to hold water or a beverage serving, a brewing chamber 11 connected to and disposed above the serving chamber 10 and which is also capable of holding the beverage serving, and a filter assembly 12 detachably connected to a lower part 13 of the filter assembly 12 for removing the solid material from the water.

The serving chamber 10 may have a closed base 14 and side walls 15 that are generally cylindrical and extend to an uppermost open end 16. The open end 16 may comprise internal threads 17 for screw engagement with complementary threads 18 on a lower part 19 of the filter assembly 12 for detachably holding the filter assembly 12 in place. The screw engagement may allow fluid communication between the interior of the serving chamber 10 and the atmosphere such that air pressure in the serving chamber 10 is maintained substantially at ambient pressure. The serving chamber 10 is preferably made of a transparent or translucent material so the user can see the colour of the beverage and, perhaps, regulate the operation of the appliance accordingly.

The brewing chamber 11 may have side walls 20 that are substantially cylindrical and extend to an open mouth 21 from a lower part 13. The lower part 13 may comprise external threads 22 for screw engagement with complementary internal threads 23 on an upper part 24 of the filter assembly 12. Coaxial walls 20, 25 of the brewing chamber 11 and the filter assembly 12 may have the same external diameter at their intersection. The lower part 13 includes apertures 26 through which the beverage passes when it enters and leaves the brewing chamber 11 during operation.

The filter assembly 12 may comprise a filter cup 27 with a filter element 28 at its base 29 for holding solid material 30 such as tea leaves or ground coffee, and a filter cup holder 31 for receiving the filter cup 27. The filter assembly 12 may be connected to the brewing chamber 11 as described above such that the solid material 30 is held between the filter element 28 and the lower part 13 of the brewing chamber 11. The filter cup 27 may have a generally cylindrical body in which a mesh disc filter element 28 is received to prevent the solid material 30 to get into the serving chamber 10.

The lower part 19 of the filter cup holder 31 may taper toward a centrally located axially aligned tubular stem 32 for detachably mounting to an upper end 33 of a tube 34. The tube 34 is straight and defines the lower section of a channel 35 providing fluid communication between the brewing chamber 11 and the serving chamber 10, while the filter cup holder 31 defines an upper section of the channel 35. The tubular stem 32 may have an annular groove 36 holding an O-ring 37 to seal a connection between the tubular stem 32 and the upper end 33 of the tube 34. When the filter assembly 12 and the serving chamber 10 are screw threaded to each other, the tube 34 passes axially through the serving chamber 10 and provides fluid communication between the lower part 19 of the filter assembly 12 and the base 14 of the serving chamber 10. A lower end 38 of the tube 34 may be slightly raised above the base 14.

A foam filter 39 adapted to capture foam includes a substantially imperforate wall 40 which may be in form of a conical frustum tapering to narrow from an upper end 41 to an opposing lower end 42, and which extends around the tube 34 and is coaxial therewith to enclose a foam-receiving space 44 between the outer side of the tube 34 and inner side of the wall 40. The wall 40 may be substantially longitudinally coextensive with the tube 34, with an upper end 41 extending to abut the lower part 19 of the filter cup holder 31 and a lower end 42 that may be slightly closer to the base 14 than the lower end 38 of the tube 34. Castellations 43 may be formed on both the upper end 41 and the lower end 42. The foam filter 39 and the tube 34 are advantageously integrally formed as tube assembly 135 to reduce manufacturing cost and simplify the assembling process by the user.

As the beverage is forced out from the lower end 38 of the tube 34, it flows generally radially away from the tube 34, and during this radial movement the foam tends to rise owing to its buoyancy. The foam thus preferentially flows into, and is retained in, the foam-receiving space 44, while the liquid beverage is able to pass through the narrow gap 45 between the lower end 42 of the continuous wall 40 and the base 14. The pressure increase in the flow owing to this narrow gap 45 also tends to crush any small bubbles that may remain entrained in the flow. As the beverage level rises in the serving chamber 10, a relatively large area above that level is available to hold foam, owing to the tapering shape. The relatively high wetted-surface-to-volume ratio of the foam-receiving space 44 tends to increase contact between the foam and the surfaces bounding this space 44 and as the foam climbs up alongside these internal surfaces it tends to be broken down. Moreover, at the end of the brewing cycle, when the serving chamber 10 is opened by lifting off the assembled brewing chamber 11/filter assembly 12/tube assembly 135 then the relatively small annular opening in the foam-receiving space 44 adjacent the lower end 42 restricts the ability for any retained foam to drop into the serving chamber 10.

A removable closure 46 may be provided for closing the open mouth 21 of the brewing chamber 11. A lower part 47 of the removable closure 46 may be provided with external threads 48 that detachably engage internal threads 49 in the brewing chamber 11.

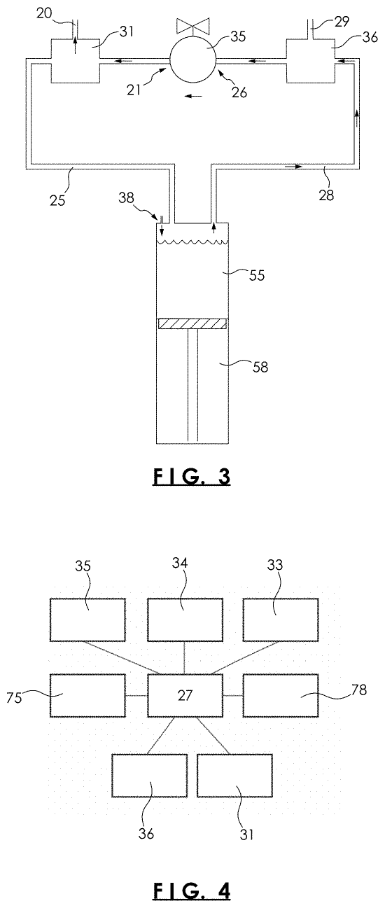

Referring to FIGS. 2 to 4, the removable closure 46 may comprise an inner shell 65 connected to an outer shell 64 to form a housing around a cavity 66. For a compact and portable design, the cavity 66 in the removable closure 46 encloses the pressure regulating system and controller 67. The pressure regulating system may comprise a pneumatic pump 51 and two valves 52, 53 that are connected, respectively, in an inlet leg 60 and an outlet leg 61 through which is air flow is driven by the pump 51. The inlet leg 60 is connected between the brewing chamber 11 and an inlet side 62 of the pneumatic pump 51. The outlet leg 61 is connected between the brewing chamber 11 and an outlet side 63 of the pneumatic pump 51. The valves 52, 53 may be 3-way 2-position solenoid valves spring biased to a normal position. In FIG. 3 the arrows indicate the direction of air flow when the brewing chamber 11 is depressurised, so the inlet leg 60 is closed by the closure of inlet 68 of valve 52, while the outlet leg 61 is open to atmosphere by the opening of outlet 69 of valve 53. FIG. 3 may show the different normal positions of the two otherwise alike valves 52, 53. To depressurize the brewing chamber 11 and draw in beverage the controller 67 operates the pneumatic pump 51, and to then pressurize the brewing chamber 11 and expel the beverage the controller 67 actuates both valves 52, 53, closing the outlet 69 of valve 53 and opening the inlet 68 of valve 52. To control the change between these two alternating modes, the appliance may comprise a pressure sensor 70 connected to the controller 67 to monitor the pressure change inside the brewing chamber 11. In particular, the controller 67 may determine from the signal provided by the pressure sensor 70 the point in the cycle at which to changeover between the modes. For instance, upper and lower pressure levels could be used to trigger this changeover. In preferred embodiments, a time rate of pressure change is determined by the controller and changeover between the modes occurs when the rate of pressure change slows to a predefined trigger level. The controller 67 may include memory in which one or more predefined trigger levels are recorded. Different predefined levels may be associated with the pressurizing and depressurizing modes, respectively. The controller 67 may also include a timer 71 and, if the controller 67 detects a fault with the pressure sensor 70, the controller 67 may operate in each mode for a predetermined time, as determined by the timer, instead of changing modes according to the predefined trigger levels.

In addition to “on” and “off” buttons 54, the removable closure 46 may further comprise a plurality of buttons 55 for the user to choose the desired brew strength (e.g. “strong”, “normal”, and “weak”). In response to the button 55 being pressed, the controller 67 may control the number of cycles of said steps (i) and (ii) to be performed such that beverage serving of different strengths can be prepared. The removable closure 46 may be provided with a receptacle 56 for connection to a power source (not shown) to power the electrical components.

The venting device may comprise a capillary tube 50 with an inner end communicating with the brewing chamber and an outer end communicating with the surroundings. As best seen in FIG. 2, the outer end of the capillary tube 50 opens into the cavity 66 which is at ambient pressure due to openings (not shown) in the outer shell 64. In the closed configuration of FIG. 2, with the exception of the air passageway of the capillary tube 50 the brewing chamber 11 is hermetically sealed when water in the serving chamber 10 closes the tube 34. In cold brewing using the device, it has been found that energy levels used in the appliance must be carefully regulated, as a small increase above maximum levels results in extracting bitter components. This capillary tube 50 is thus a tuning device for effectively derating the pump 51 to achieve a desired energy level, and thus allowing lower cost off-the-shelf motorised pumps with somewhat higher rated output than desired to be used to achieve a design extraction rate.

To make a cold brew coffee beverage, for example, the filter cup 27 is placed inside the filter cup holder 31 to form the filter assembly 12 with ground coffee filled into the filter cup 27. The filter cup holder 31 is then screwed to the brewing chamber 11 such that the ground coffee is disposed between the filter cup 27 and the lower part 13 of the brewing chamber 11 and the filter assembly 12 is secured against being displaced from the brewing chamber 11, before screwing the removable closure 46 over the open mouth 21 of the brewing chamber 11. The tube assembly 135 is connected to the tubular stem 32 of the filter assembly 12. An amount of water at room temperature is placed into the serving chamber 10, followed by screwing the brewing chamber 11 to the serving chamber 10.

When the user connects the appliance to a power source and touches the buttons 54, 55 to respectively actuate the appliance and select the brew strength, the controller 67 is started and an automated extraction cycle is started by turning on the pneumatic pump 51. Initially, the upstream valve 52 is closed and the downstream valve 53 is opened to atmosphere, exhausting the air drawn by the pneumatic pump 51, and depressurizing the brewing chamber 11, where this pressure decrease acts to draw the water out of the serving chamber 10 and up through the tube 34 and the filter assembly 12 into the brewing chamber 11 to extract and dissolve soluble components of the ground coffee to form the coffee serving. After substantially all the water is drawn out of the serving chamber 10, the rate of pressure change determined by the controller 67 according to the signal from the pressure sensor 70 reduces until it reaches a predetermined value. Once the controller 70 detects this predetermined rate, it triggers a changeover from the depressurizing mode to the pressurizing mode by closing the valve 53 and opening the valve 52 to atmosphere. The pneumatic pump 51 pumps ambient air drawn through the valve 52 into the brewing chamber 11, pressurizing the brewing chamber 11 and pushing the coffee serving out of the brewing chamber 11 and down through the filter assembly 12, the tube 34 and the foam filter 39 into the serving chamber 10. In other words, the water passes through the filter assembly 12 and extracts soluble components from the ground coffee twice in one extraction cycle. The increase in pressure in the brewing chamber 11 during the pressurizing mode is again monitored by the controller 70. As the brewing chamber 11 is continuously filled by air and the coffee serving is continuously pushed out of the brewing chamber 11, the rate of change of pressure in the brewing chamber 11 reduces until it reaches a second predetermined rate. Once this second predetermined rate is detected, the controller 67 triggers a changeover from the pressurizing mode to the depressurizing mode.

While the appliance remains on, the controller 67 may repeat this extraction cycle of alternately de-pressurizing and pressurizing the brewing chamber 11 for multiple times to continue the extraction process until a desired level of extraction is obtained. As describe above, different numbers of extraction cycles may be user selectable according to the concentration of the beverage serving required.

Aspects of the present invention have been described by way of example only and it should be appreciated that modifications and additions may be made thereto without departing from the scope thereof.

1. An appliance for dissolving components of a solid material in water to make a beverage, comprising:
a serving chamber adapted to hold a beverage serving, the serving chamber having a base;
a brewing chamber adapted to hold the beverage serving;
a pressure regulating system for depressurizing and pressurizing the brewing chamber with air;
a channel providing fluid communication between the brewing chamber and the base of the brewing chamber;
a filter assembly for removing the solid material from the water, the filter assembly disposed in the channel, and
a controller that controls the pressure regulating system to alternately (i) depressurize the brewing chamber to draw water out of the serving chamber and through the channel and the filter assembly into the brewing chamber and (ii) pressurize the brewing chamber to push the beverage serving from the brewing chamber through the filter assembly and the channel to the serving chamber.

2. The appliance according to claim 1, wherein the brewing chamber, filter assembly and serving chamber are detachably connected together, with the brewing chamber disposed uppermost and the filter assembly disposed between the brewing chamber and the serving chamber, and further comprising a tube releasably connectable at its upper end to the filter assembly, and wherein its lower end is spaced from the base, the tube defining a lower section of the channel.

3. The appliance according to claim 2, wherein the tube is straight and extends substantially centrally through the serving chamber.

4. The appliance of claim 1, further comprising a foam filter adapted to remove foam formed in the beverage.

5. The appliance according to claim 4, wherein the foam filter comprises a wall extending around and spaced apart from the tube and substantially longitudinally coextensive therewith.

6. The appliance according to claim 5, wherein the wall is substantially imperforate.

7. The appliance according to claim 6, wherein the wall includes castellations at an upper end thereof and/ or further comprises castellations at an opposing lower end thereof.

8. The appliance according to claim 5, wherein the wall of the foam filter tapers to narrow toward its lower end.

9. The appliance according to claim 8, wherein the wall is in form of a conical frustum.

10. The appliance according to claim 4, wherein the foam filter and the tube are integrally formed.

11. The appliance according to claim 4, wherein the serving chamber comprises transparent walls or a transparent window and the wall of the foam filter is opaque.

12. The appliance according to claim 1, wherein a removable closure closes an open mouth of the brewing chamber, and the removable closure encloses the pressure regulating system and the controller.

13. The appliance according to claim 1, wherein a venting device provides a small metered air flow between the brewing chamber and the surrounding atmosphere during both depressurizing and pressurizing the brewing chamber.

14. The appliance according to claim 13, wherein the venting device comprises a capillary tube.

15. The appliance according to claim 1, wherein the pressure regulating system comprises a circuit having a first leg connected between the brewing chamber and an inlet side of the pneumatic pump and a second leg connected between the brewing chamber and an outlet side of the pneumatic pump, and a first 3-way solenoid valve in the first leg and a second 3-way solenoid valve in the second leg.

16. The appliance according to claim 1, wherein a lower part of the filter assembly is received in an upper part of the serving chamber, and the brewing chamber and the serving chamber are coaxially disposed.

17. The appliance according to claim 1, wherein the appliance further comprises a pressure sensor and a signal from the pressure sensor triggers a changeover between pressurizing and depressurizing the brewing chamber.

18. The appliance according to claim 17, wherein the controller determines a rate of change from the pressure signal and triggers the changeover when a predetermined rate of pressure change is measured.

19. The appliance according to claim 1, wherein the filter assembly comprises a filter cup with a filter element at its base and a filter cup holder for receiving the filter cup, the solid material is held between the filter element and a lower part of the brewing chamber.

20. The appliance according to claim 19, wherein the filter element comprises mesh.

21. The appliance according to claim 1, wherein the filter assembly and the brewing chamber are screw threaded to each other.

22. The appliance according to claim 1, wherein the appliance lacks a heating element for heating the water.

23. A method for making a beverage comprising alternately:
a. depressurizing a brewing chamber to draw water out of a serving chamber and through a channel in which a filter assembly holding solid material and into a brewing chamber to thereby dissolve components of the solid material in the water, and
b. pressurizing the brewing chamber to push the beverage from the brewing chamber through the filter assembly and the channel to the serving chamber.

24. The method according to claim 23, wherein the channel is formed in a tube and, after passing through the tube, at least a portion of the beverage passes through a foam filter surrounding a length of the tube.

25. The method according to claim 23, wherein air pressure in the serving chamber is maintained substantially at ambient pressure.

26. The method according to claim 23, wherein the steps (i) and (ii) of alternately depressurizing and pressurizing the brewing chamber are repeated for multiple cycles.

27. The method according to claim 23, further comprising:
placing a filter cup into a filter cup holder to form a filter assembly;
placing an amount of a solid material into the filter assembly;
connecting the filter assembly to a brewing chamber;
connecting the brewing chamber to a removable closure;
connecting the filter assembly to a liquid passageway;
placing an amount of water into a serving chamber; and
connecting the brewing chamber to the serving chamber.
